(19) United States
(12) Patent Application Publication
(10) Pub. No.: US 2015/0356803 A1
(43) Pub. Date: Dec. 10, 2015

(54) ITEM AUTHENTICATION

(71) Applicant: David Jarrett Collins, Duxbury, MA (US)

(72) Inventor: David Jarrett Collins, Duxbury, MA (US)

(21) Appl. No.: 14/545,389

(22) Filed: Apr. 29, 2015

Related U.S. Application Data
(60) Provisional application No. 61/997,513, filed on Jun. 4, 2014.

(51) Int. Cl. G07C 11/00; G06K 19/06

(52) U.S. Cl. CPC G07C 11/00; G06K 19/06037

(57) ABSTRACT

An item authentication system for UII item data encoded on a Data Matrix tag uses the Data Matrix Extended Channel Interpretation to transit the UII tag data to an authentication data stream.

### CROSS REFERENCE TO RELATED APPLICATION

This application claims the priority of Provisional Application No. 61/997,513 filed Jun. 4, 2014, the contents of which are incorporated herein in their entirety.

### FIELD OF THE INVENTION

This invention relates to a scanned-code system and method to authenticate items as they move in commerce in order to detect an inauthentic item and, more particularly, to an improved authentication system and method implemented with a two dimensional Data Matrix tag encoded with a code complying to a protocol for Uniquely Identifying Items (UII).

### BACKGROUND

Items are routinely tracked and accounted for by printing or attaching to the item a one or two dimensional UII encoded tag, such as a linear bar code tag or a two dimensional Data Matrix tag. The encoded data can be read by an appropriate scanner. The alphanumeric data that uniquely identifies the item can he displayed at the scanner site, and/or transmitted to a remote location. In a simple example, the encoded data includes data identifying the manufacturer and a character set that uniquely identifies the item, such as a sequentially assigned number.

There are several Uniquely Identifying Item (UII) code protocols that have been established by various entities. These include the U.S. Department of Defense (DOD) Guide to Uniquely Identifying Items (UII) entitled: “Assuring Valuation, Accountability and Control of Government Property” Version 2.5, which is incorporated herein by reference. As will be appreciated by those skilled in the art, this standard and other standards define data fields and the code characters that mark the beginning and end of each respective field. The DOD standard and other standards ensure that when the code is scanned into an intelligent network, the data fields are aligned and processed correctly. U.S. Pat. No. 7,639,144 entitled System and Method of Validating Asset Tracking Codes provides an extended description of several UII formats in conformance with the DOD standard.

A Data Matrix UII tag of the prior art provides a first level of counterfeit and gray market item detection. If there is no tag, the item is suspect. A counterfeiter or operator on the gray market can copy one of the authentic tags and reproduce it on their items. But such items are easy to identify as not authentic since each scanned tag on successive items will have the same data, not data unique to each item. A more sophisticated and harder to detect system employed by counterfeiters, is to read the data from a valid tag, generating tags with this data plus a unique character on each tag.

There have been a number of proposals in the prior art to make UII tags harder to counterfeit and/or counterfeit tags more readily detectable. These proposals include using randomly generated numbers assigned to each tag rather than a sequence of numbers. Additional proposals include holographic tags, encrypted tags, and the use of a tagent. Each of these additional proposals adds a layer of security against counterfeiting but at cost in terms of implementation and its implementation can result in a departure from standards that have been approved for encoding UII tags.

### BRIEF DESCRIPTION OF THE INVENTION

An object of this invention is the provision of an item authentication system for UII encoded item data on a Data Matrix tag that provides robust protection while complying with UII and Data Matrix standards.

Briefly, this invention contemplates the use of the Extended Channel Interpretation (ECI) suffix that the Data Matrix specification provides in order to transit the UII tag data to an authentication data stream. As will be appreciated by those skilled in the art, ISO/IEC 16022 is the international standard that defines the Data Matrix requirements, and is incorporated herein by reference. The Data Matrix ISO/IEC 16022 standard provides manufactures of bar code equipment and users of the technology with specifications to which they can refer in developing equipment and applications. A Data Matrix scanner includes a processor that is programed to generate a display message code from the data stream generated by a scanned Data Matrix tag typically an ASCII message, the so called default message. The ECI protocol allows the data stream generated by a scanned Data Matrix tag to be processed by suitable scanner program to provide an interpretation other than the default ASCII message. In accordance with the teachings of this invention, the ECI calls up an authentication application on the scanner's processor that transits the Data Matrix UII tag data to a user defined authentication data in a closed system.

### DESCRIPTION OF THE DRAWINGS

FIG. 1 is a pictorial block diagram of the data fields of a UII compliant Data Matrix code that includes a character in the ECI field.

FIG. 2 is a block diagram of one embodiment of a UII compliant Data Matrix authentication scanner system in accordance with the teachings of this invention.

FIG. 3 is a flow chart illustrating the operation of the authentication system shown in FIG. 2.

FIG. 4 is a block diagram of a cloud based authentication system incorporating the teachings explained in connection with FIGS. 2.

FIG. 5 is a block diagram of another authentication system incorporating the teachings explained in connection with FIGS. 2 and 3.

### DETAILED DESCRIPTION OF THE INVENTION

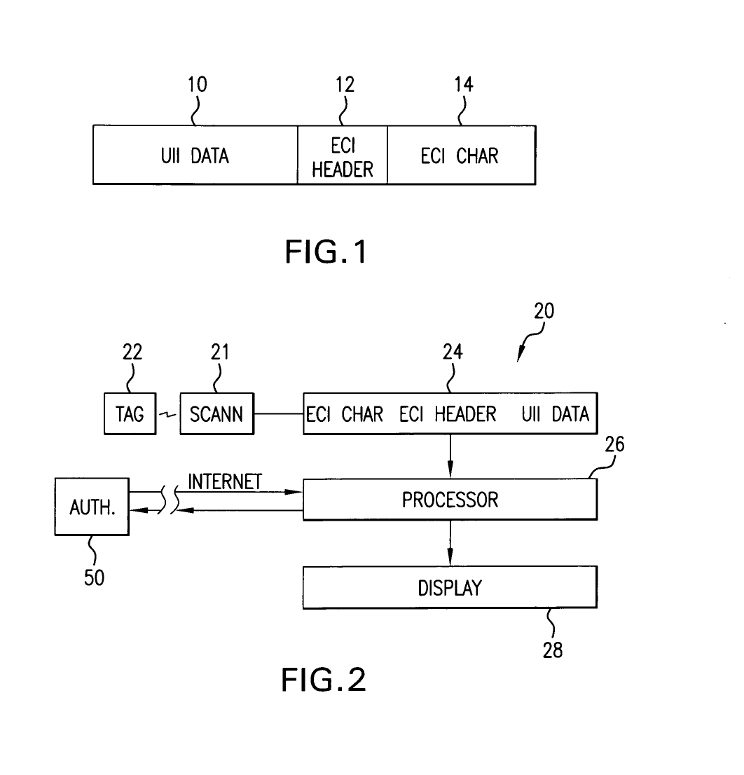

Referring now to FIG. 1, as will be appreciated by those skilled in the art, a UII compliant Data Matrix tag is comprised of a field 10 into which UII compliant data is encoded. In addition, the Data Matrix standard provides for an ECI header field 12, which may be followed by an ECI character(s) in field 14. Commercially available Data Matrix enabled scanners process the scanned data and display the data. In the absence of an ECI character, the scanner program processes data in a so called default format, usually ASCII. The ECI character allows a scanner programmed with, for example, an ASCII default program, to call up and process data for display in an alternative format. The ECI protocol provides a consistent method to specify particular interpretations on byte values after decoding and before printing. Specific interpretations are listed in AIM Inc. Extended Channel Interpretations Character Set Register. The ECI character can be interpreted by readers enabled to transmit the symbol identifiers. Readers not enabled to transmit the symbol identifiers can be used if the ECI can be handled entirely within the reader.

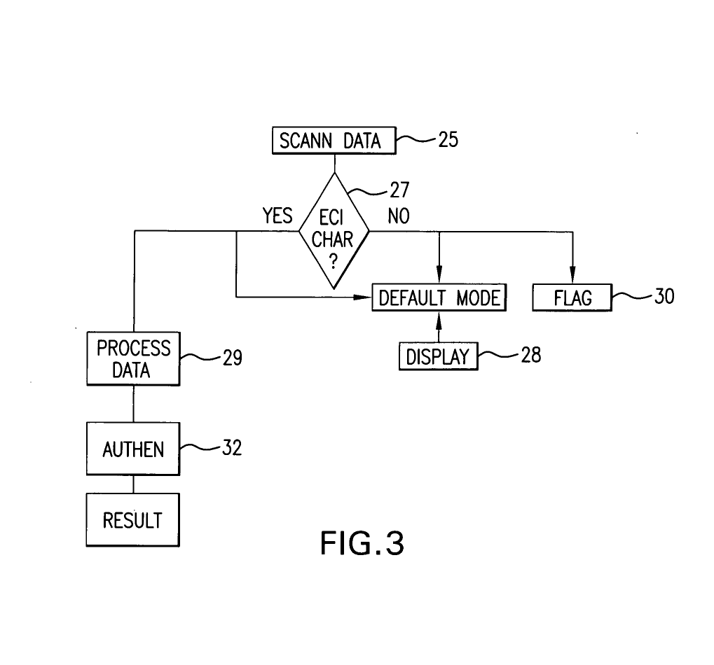

Referring now to FIGS. 2 and 3, they show and illustrate the item authentication system of this invention incorporated in a commercially available Data Matrix enabled scanner such as those available from Honeywell and Motorola and indicated here by the general reference 20. A conventional scanning optical system 21 scans the Data Matrix code pattern on a UCII tag 22. A buffer 24 stores the data read from the tag, namely an ECI character if there is an ECI character in the tag data, the ECI header, and the UCII data. The scanned data 25 is coupled to a processor 26 which processes the data and generates an output to drive a display 28. Processor software (decision block 27 FIG. 3) determines if there is an ECI character. In the illustrative embodiment of FIG. 3, the processor 26 operates in the so called “default” mode to drive the display 28. Typically the default mode is ASCII. More generally it is the expected display code format. In the prior art the ECI character is used to generate an alternative display code format. It should be noted here, that in accordance with the teachings of this invention, an ECI character does not necessarily change the display format; the so called default format can be used to present the UII data both when an ECI character is present and when it is not. But in accordance with this invention, if there is no ECI character, the processor flags (block 30) the item as not authentic. If there is an ECI character, the software (block 29) processes the data in order to make a determination of authenticity (block 32).

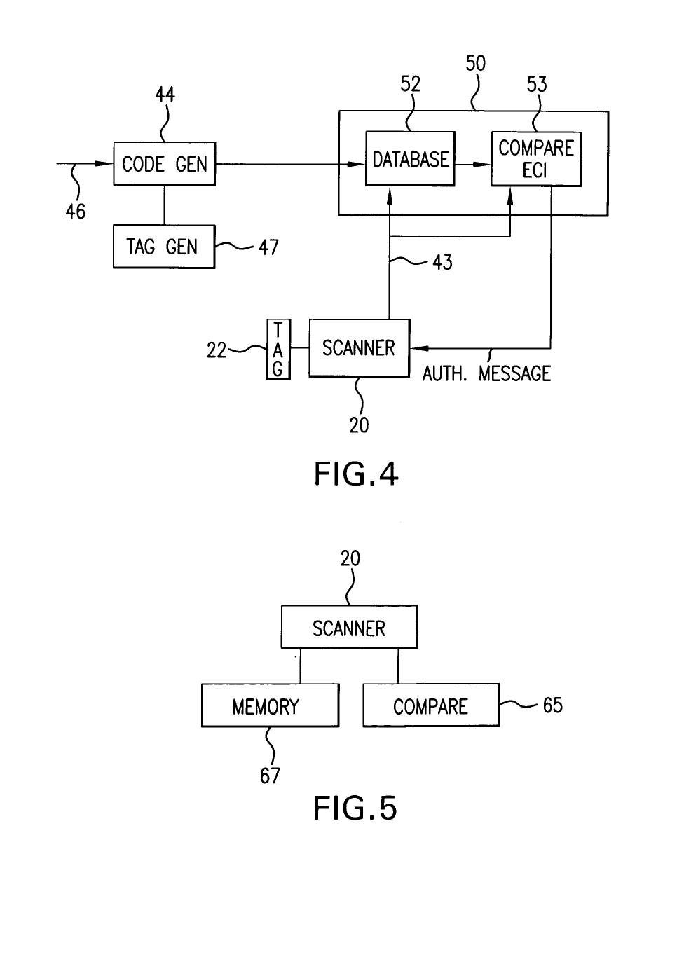

Referring now to FIG. 4, in a preferred embodiment of the invention, a source of the items to be tagged with a UII Data Matrix tag sends the data it wants incorporated in the tag to a UII code generator 44. In this preferred embodiment, the generator 44 is cloud based and a Web communications link 46 connects the source with the code generator 44. The code generator 44 generates a series of UII codes based on the furnished data, with each code in the series unique to each item. In addition it adds an ECI header and an ECI character to each UII code. The generated series of codes are transferred to a facility 47 that produces a series of Data Matrix tags that incorporate the code data. These tags are attached to the product items.

Tag code data from code generator 44 is also transferred via a Web link 45 to a cloud based authentication server 50 that includes a database 52 where the codes generated by code generator 44 are stored, and a comparator 53 that compares a stored code with a scanned code.

Code generator 44 formats and encodes the item data in accordance with a UII standard that includes a character unique to each item. In addition it encodes the six digit ECI header and an ECI character or characters following the header. For example, the ECI character may be an additional random number assigned to each UII tag. The presence of an ECI character(s) triggers the program resident on the scanner processor 26 to generate an authentication message, which includes UII data and the ECI character. This message is transmitted via a Web link 43 to the cloud-resident authentication server 50. The authentication server 50 searches the database for tag data corresponding to the UII data of a scanned tag data. A comparator program 42 compares the transmitted scanned tag data with the stored UII data. If there is a match between the stored ECI data and the scanned ECI data, the system transmits back to the scanner an authentication message; if there is a match, the item is probably authentic, and if no match, probably not authentic.

In an additional embodiment of the invention shown in FIG. 5, the scanner 20, as described in FIGS. 2 and 3, has validation unit resident on the scanner. The validation unit includes a comparator 65 and a replaceable memory chip 67 loaded with tag data generated by the code generator 44. This allows a thusly enabled scanner to detect an inauthentic item where the scanner does not have a link the Web based validation described above. The tag data may be encoded in the replaceable memory chip 67 at tag generator facility, for example, and inserted in the scanner. The memory chip can be read protected. For example, the tag data can only be read from the chip in response to an encrypted signal from the processor 26.

It will be appreciated the system and method of this invention provides and authorized cloud repository for performing cloud based functions such as (a) generating code words to assign after the latch character under the ECI translation; (b) archiving those code/UII combinations together with other metadata related to the serial number assignment, according to UII policy rules, and (c) when an authorized scanner passes the UII data with ECI data to a hosted data base, then replying with a message regarding confidence or doubt in the item's authenticity.

Licensed and registered scanners perform item inspection as necessary according to that scanner's role in the supply chain. End users can be provided with free or inexpensive authentication apps for iOS and android devices such as smart phones that are programed to perform a scan-and-upload function. A user of these devices would not see the code words but only the item identification information, and the system would indicate that this item is authentic, inauthentic, or uncertain under rules of the process.

1. A Data Matrix tag encoded with UII data and an ECI character that authenticates said UII data.

2. A Data Matrix tag as in claim 1 wherein said authentication character is a randomly generated character.

3. A Data Matrix tag as in claim 1 wherein said authentication character is encrypted.

4. A method for identifying authenticating an item including the steps of:
(a) generating a series of WI tag codes with an ECI character for use with Data Matrix tags;
(b) storing said codes in a cloud based database;
(c) producing a series of tags each tag including one of said series of tag codes;
(d) connecting one of said series of tags respectively to one of a series of items;
(e) scanning one or more of said items with a Data Matrix enabled scanner;
(f) transmitting data from said scanning step to said database;
(g) comparing said ECI character in said data transmitted in step (f) with ECI character data stored in said database;
(h) generating a flag signal indicating an inauthentic item if no match is found in stem (g).

5. A method for identifying authenticating an item including the steps of:
(a) generating a series of WI tag codes with an EU. character for use with Data Matrix tags;
(b) storing said codes in a database located on a Data Matrix scanner;
(c) producing a series of tags each tag including one of said series of tag codes;
(d) connecting one of said series of tags respectively to one of a series of items;
(e) scanning one or more of said items with said Data Matrix enabled scanner;
(f) comparing said ECI character in said data from step (e) with data stored in said database;
(g) generating a flag signal indicating an inauthentic item if no match is found in step (f).
